(19) United States
(12) Patent Application Publication
(10) Pub. No.: US 2021/0365157 A1
(43) Pub. Date: Nov. 25, 2021

(54) FINGERPRINT SENSOR INTEGRATED TOUCH SCREEN PANEL

(71) Applicant: E&H. CO., LTD., Asan-Si (KR)

(72) Inventors: Soo Ho Do, Pyeongtaek-Si (KR); Gap Deuk Song, Daegu (KR); Sang kyu Kim, Daejeon (KR); Jae Gu Lee, Cheonan-Si (KR); Man Seob Shin, Daejeon (KR)

(73) Assignee: E&H. CO., LTD., Asan-Si (KR)

(21) Appl. No.: 17/323,869

(22) Filed: May 18, 2021

(30) Foreign Application Priority Data
May 19, 2020 (KR) 10-2020-0059916

(51) Int. Cl. G06F 3/044; G06F 3/041

(52) U.S. Cl. CPC G06F 3/0446; G06F 3/0443; G06F 2203/04112; G06F 3/0412; G06F 3/04164

(57) ABSTRACT

The present invention relates to a fingerprint sensor-integrated touch screen panel, in which, since an electrode disposed to be parallel to a driving electrode is used as a receiving electrode, a bezel area is formed in an extending direction of the driving electrode, thereby minimizing the bezel area and allowing the number of channels required for fingerprint sensing to be reduced.

### CROSS-REFERENCE TO RELATED APPLICATION

This application claims priority to and the benefit of Korean Patent Application No. 2020-0059916, filed on May 19, 2020, the disclosure of which is incorporated herein by reference in its entirety.

### BACKGROUND

### 1. Field of the Invention

The present invention relates to a fingerprint sensor-integrated touch screen panel, and more particularly, to a capacitive fingerprint sensor-integrated touch screen panel which allows fingerprint sensing and touch sensing.

### 2. Discussion of Related Art

With the development of computer technologies, multipurpose computer-based systems such as notebook computers, tablet personal computers (PCs), smartphones, personal digital assistants, automatic teller machines, and search guidance systems have been developed. Since the systems typically store a large amount of confidential data such as business information or business secrets as well as personal information related to personal privacy, in order to protect the data, there is a need to strengthen security.

To this end, conventionally, fingerprint sensors, which may strengthen security by performing a registration or authentication on a system using a fingerprint, are known.

Fingerprint sensors are sensors that detect a fingerprint of a human being. The fingerprint sensors are largely classified into optical fingerprint sensors and capacitive fingerprint sensors. Among the fingerprint sensors, a type of capacitive fingerprint sensor uses a difference in an amount of electricity charged between a ridge and a valley in contact with the fingerprint sensor.

FIG. 1 is a schematic plan view illustrating a channel arrangement method for touch sensing in the conventional capacitive touch screen panel.

Referring to FIG. 1, the capacitive touch screen panel includes an active area AA in which electrodes Tx and Rx are formed and a bezel area BA in which connection lines 2 and 4 connected to the electrodes in the active area AA and connection pad parts 3 and 5 are formed. When the bezel area BA is positioned on a front side of a display, the bezel area is disposed outside a screen area formed by the active area.

The active area AA includes a plurality of driving electrodes Tx disposed on a transparent substrate SUB in a first direction (for example, an x-axis direction) and a plurality of sensing electrodes Sx disposed in a second direction (for example, a y-axis direction) intersecting the first direction. Intersections between the driving electrodes Tx and the sensing electrodes Sx are sensing nodes, and after a driving pulse is applied to the driving electrode Tx, a change in quantity of electric charges charged in the sensing node is detected through the sensing electrode to determine whether a touch occurs and a position of the touch.

In the bezel area BA, the connection lines 2 connected to the driving electrodes Tx, the connection lines 4 connected to the sensing electrodes Sx, and the connection pad parts 3 and 5 are formed. The connection pad parts 3 and 5 are bonded and connected to a controller such as an integrated circuit (IC) chip for control.

In the display to which such a conventional touch screen panel is applied, the bezel area BA for accommodating the connection lines 2 connected to the driving electrodes Tx disposed in the first direction, the connection lines 4 connected to the sensing electrodes Sx disposed in the second direction, and the connection pad parts 3 and 5 should be formed outside the active area AA in the first direction and the second direction, and a large number of the driving electrodes Tx and a large number of the sensing electrodes Sx are required for sensing fingerprint valleys. Thus, the bezel is implemented to be inevitably wide.

In addition, conventionally, a fingerprint sensor-integrated touch screen panel, in which a fingerprint sensing function is conferred to such a capacitive touch screen panel, has been used. However, due to the formation of a separate fingerprint sensor area for fingerprint sensing, there is a problem such as an increase in thickness of a panel.

### SUMMARY OF THE INVENTION

The present invention is directed to providing a fingerprint sensor-integrated touch screen panel in which, since an electrode disposed to be parallel to a driving electrode is used as a receiving electrode, a bezel area is formed in an extending direction of the driving electrode, thereby minimizing the bezel area.

The present invention is also directed to providing a fingerprint sensor-integrated touch screen panel allowing the number of channels required for fingerprint sensing to be reduced.

According to an aspect of the present invention, there is provided a fingerprint sensor-integrated touch screen panel including a driving/receiving electrode group which includes a plurality of sub-driving/receiving electrode groups, wherein each of the sub-driving/receiving electrode groups includes a plurality of driving electrodes and a plurality of receiving electrodes disposed to be parallel to a first direction, a sensing electrode group forming an active area which includes a plurality of touch sensing electrode rows and a plurality of fingerprint sensing electrodes, wherein the plurality of touch sensing electrode rows and the plurality of fingerprint sensing electrodes are disposed in a second direction intersecting the first direction to intersect the driving/receiving electrode group, and wherein touch sensing electrodes corresponding to the sub-driving/receiving electrode groups are disposed in a line in the touch sensing electrode row, a connection electrode group which is formed at one side of the sensing electrode group in the first direction, includes a plurality of connection electrodes disposed to be parallel to the second direction so as to intersect the driving/receiving electrode group, and forms a bezel area, and an insulating layer which is disposed between the driving/receiving electrode group and the sensing electrode group and between the driving/receiving electrode group and the connection electrode group and has via holes formed in some intersections between the receiving electrodes and the touch and fingerprint sensing electrodes and some intersections between the driving electrodes of the driving/receiving electrode group and the connection electrodes.

In the driving/receiving electrode group, the receiving electrode may be disposed between the driving electrodes.

The driving/receiving electrode group may include a dummy electrode which is disposed between the driving electrodes and is not connected to the touch sensing electrode and the fingerprint sensing electrode.

Each of the electrodes of the driving/receiving electrode group may have a line width of 10 μm to 200 μm and a pitch of 20 μm to 400 μm, and each of the electrodes of the sensing electrode group may have a line width of 10 μm to 200 μm and a pitch of 20 μm to 400 μm. Each of the electrodes of the driving/receiving electrode group, each of the electrodes of the sensing electrode group, and each of the electrodes of the connection electrode group may be arranged with the same line width and pitch and may be formed to have a line width of 10 μm to 200 μm and a pitch of 20 μm to 400 μm.

The driving electrodes of the sub-driving/receiving electrode group at one side and the driving electrodes of the sub-driving/receiving electrode group at the other side may be formed in the same arrangement so as to sequentially correspond to each other and may be connected so that a driving pulse is transmitted through the connection electrode.

In the sensing electrode group, the fingerprint sensing electrode may be disposed between the touch sensing electrode rows.

The active area may include a plurality of touch sensing areas parallel to the second direction, each of the touch sensing areas may be divided into a plurality of sub-touch sensing areas so as to correspond to the sub-driving/receiving electrode groups, each of the sub-driving/receiving electrode groups may correspond to the plurality of sub-touch sensing areas disposed in the first direction, and each of the sub-driving/receiving electrode groups may include a touch receiving electrode group including touch receiving electrodes commonly connected to the plurality of touch sensing electrodes of a corresponding one of the sub-touch sensing areas.

The active area (AA) may include fingerprint sensing areas each including the plurality of fingerprint sensing electrodes, the fingerprint sensing area may be divided into a plurality of sub-fingerprint sensing areas so as to correspond to the sub-driving/receiving electrode groups, each of the plurality of fingerprint sensing electrodes in the fingerprint sensing area may form a connection pattern that is connected to correspond to each fingerprint receiving electrode of a fingerprint receiving electrode group in the driving/receiving electrode group, and the fingerprint receiving electrode group may receive signals of the sub-fingerprint sensing areas in an overlapping manner.

The active area may include a plurality of fingerprint sensing areas parallel to the second direction and adjacent to each other in the first direction, and the fingerprint receiving electrode group may receive signals from the plurality of fingerprint sensing areas in an overlapping manner by being commonly connected to the plurality of fingerprint sensing areas in a manner in which a connection pattern between the fingerprint sensing electrodes and the fingerprint receiving electrodes in one of the fingerprint sensing areas is formed to be the same as a connection pattern between the fingerprint sensing electrodes and the fingerprint receiving electrodes in another one of the fingerprint sensing areas.

The bezel area may be formed in one direction outside the active area in an extending direction of the driving/receiving electrode group.

The bezel area may be formed to be foldable on a flexible circuit board and the bezel area may be folded on a rear side of the display when being applied to the display. Thus, it is possible to form a bezel-free front side of the display.

### BRIEF DESCRIPTION OF THE DRAWINGS

FIG. 1 is a schematic plan view illustrating a channel arrangement method for touch sensing in a conventional capacitive touch screen panel.

FIG. 2 is a schematic plan view illustrating a configuration of a touch screen panel according to the present invention.

FIG. 3 is an exploded cross-sectional view of a partial area of an active area of the touch screen panel according to an embodiment of the present invention.

FIG. 4 is a plan view for describing a connection relationship between driving/receiving electrode groups and connection electrodes in a bezel area of a touch screen panel according to an embodiment of the present invention.

FIG. 5 is a plan view illustrating a connection relationship between touch sensing electrodes and touch receiving electrodes in a touch screen panel according to an embodiment of the present invention.

FIG. 6 is a view for describing an operation of a touch sensing mode in a touch screen panel according to an embodiment of the present invention.

FIG. 7 is a plan view for describing a connection relationship between fingerprint sensing electrodes and fingerprint receiving electrodes in a touch screen panel according to an embodiment of the present invention.

FIG. 8 is a view for describing a signal receiving relationship in a fingerprint sensing area in a touch screen panel according to an embodiment of the present invention.

FIG. 9 illustrates a case in which a fingerprint touch occurs over a plurality of sub-fingerprint sensing areas in a touch screen panel according to an embodiment of the present invention and an example of a procedure of recognizing a fingerprint according to the fingerprint touch.

FIG. 10 shows schematic views illustrating a touch screen to which a touch screen panel is applied according to the present invention.

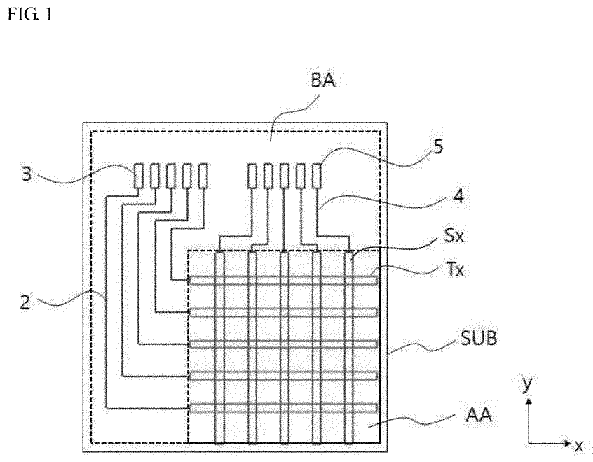

### DETAILED DESCRIPTION OF EXEMPLARY EMBODIMENTS

Hereinafter, specific embodiments of the present invention will be described in detail with reference to the accompanying drawings. In describing the present invention, detailed descriptions related to well-known functions or configurations obvious to those skilled in the art related to the present invention will be omitted in order to not unnecessarily obscure the essence of the present invention.

Terms used in the present specification are used only to describe specific embodiments and are not intended to limit the present invention. A singular form may include a plural form when there is no clearly opposite meaning in the context, and components that are distributed and implemented may be implemented in a combined form unless there is a specific limitation. In the present specification, it is to be understood that the terms such as “include” and “has” are intended to designate that a feature, number, step, operation, element, part, or a combination thereof, which is disclosed in the specification, exists, and to include that one or more other features, numbers, steps, operations, elements, parts, or combinations thereof exist or may be provided additionally.

It will be understood that, although the terms “first,” “second,” and the like may be used herein to describe various components, these components should not be limited by these terms. The terms are used only for the purpose of distinguishing one element from another element. For example, without departing from the scope of the present invention, a first element could be termed a second element, and similarly, a second element could be also termed a first element.

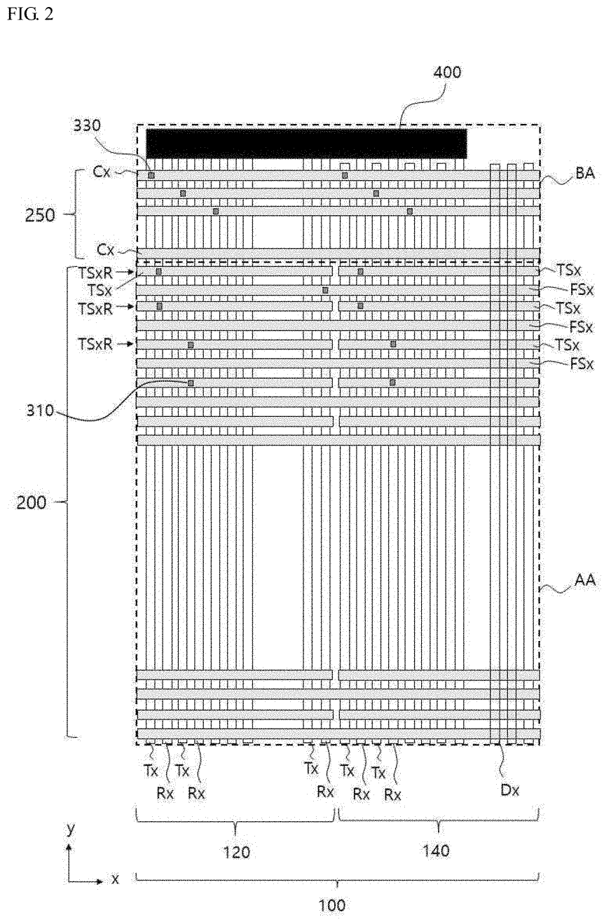

FIG. 2 is a schematic plan view illustrating a configuration of a touch screen panel according to the present invention.

Referring to FIG. 2, the touch screen panel according to the present invention includes an active area AA, in which touch and fingerprint sensing signals are generated, and a bezel area BA formed outside the active area AA. When the bezel area BA is positioned on a front side of a display, the bezel area BA is positioned outside a screen area formed by the active area AA.

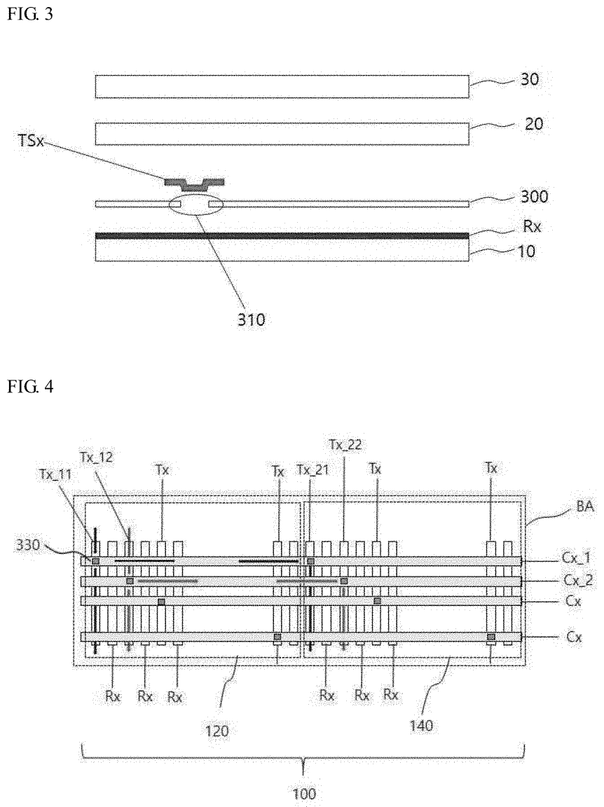

The touch screen panel includes a driving/receiving electrode group 100, a sensing electrode group 200, a connection electrode group 250, and an insulating layer 300 (see FIG. 3).

The driving/receiving electrode group 100 includes a plurality of sub-driving/receiving electrode groups 120 and 140, and each of the sub-driving/receiving electrode groups 120 and 140 includes a plurality of driving electrodes Tx and a plurality of receiving electrodes Rx. The plurality of driving electrodes Tx and the plurality of receiving electrodes Rx are disposed in the active area AA and the bezel area BA to be parallel to a first direction (y-direction in the drawing).

The plurality of sub-driving/receiving electrode groups 120 and 140 include a first sub-driving/receiving electrode group 120 including the driving electrodes Tx for receiving a driving pulse from an external source and a second sub-driving/receiving electrode group 140 including the driving electrodes Tx for receiving a driving pulse from the driving electrodes Tx of the first sub-driving/receiving electrode group 120. Each driving electrode Tx of the first sub-driving/receiving electrode group 120 is connected to a controller 400 to receive a driving pulse. Each driving electrode Tx of the second sub-driving/receiving electrode group 140 receives a driving pulse from the driving electrode Tx of the first sub-driving/receiving electrode group 120 through a connection electrode Cx. The second sub-driving/receiving electrode group receiving a driving pulse from the first sub-driving/receiving electrode group 120 may be provided as a plurality of second sub-driving/receiving electrode groups. In the present specification, the second sub-driving/receiving electrode group represents sub-driving/receiving electrode groups that receive a driving pulse from the first sub-driving/receiving electrode group 120.

The sensing electrode group 200 includes a plurality of touch sensing electrode rows TSxR and a plurality of fingerprint sensing electrodes FSx which are disposed to be parallel to a second direction (x-direction in the drawing) intersecting the first direction. The plurality of touch sensing electrode rows TSxR and the plurality of fingerprint sensing electrodes FSx intersect the driving/receiving electrode group 100 to form the active area AA in which touch sensing and fingerprint sensing are possible. The first direction and the second direction may be directions orthogonal to each other. In this drawing, the first direction is illustrated as the y-direction, and the second direction is illustrated as the x-direction. The touch sensing electrode row TSxR includes a plurality of touch sensing electrodes TSx arranged in a line. Each touch sensing electrode TSx corresponds to each of the sub-driving/receiving electrode groups 120 and 140. Accordingly, the touch sensing electrode row TSxR includes the touch sensing electrodes TSx which are disposed in a line and correspond to the first and second sub-driving/receiving electrode groups 120 and 140. The touch sensing electrodes TSx constituting the touch sensing electrode row TSxR are spaced apart from each other.

The fingerprint sensing electrode FSx intersects the sub-driving/receiving electrode groups 120 and 140 and extends in the second direction.

The connection electrode group 250 is formed in the bezel area BA outside the sensing electrode group 200 in the first direction. The connection electrode group 250 includes a plurality of connection electrodes Cx. The connection electrodes Cx are disposed to be parallel to the second direction (x-direction in the drawing) intersecting the first direction. Each connection electrode Cx of the connection electrode group 250 is parallel to each electrode of the sensing electrode group 200.

The insulating layer 300 (see FIG. 3) is disposed between the driving/receiving electrode group 100 and the sensing electrode group 200 and between the driving/receiving electrode group 100 and the connection electrode group 250. The sensing electrode group 200 and the connection electrode group 250 may be disposed to be coplanar with each other. In this case, the insulating layer 300 may be formed as a single layer. Each connection electrode Cx of the connection electrode group 250 may be formed simultaneously when each of the electrodes TSx and FSx of the sensing electrode group 200 is formed.

The insulating layer 300 includes a plurality of via holes 310 and 330. The via holes 310 are formed in some intersections which are required to constitute a network among intersections between the receiving electrodes Rx of the driving/receiving electrode group 100 and the touch sensing electrodes TSx or the fingerprint sensing electrodes FSx of the sensing electrode group 200 in the active area AA. The via hole 310 electrically connects the receiving electrode Rx and the touch sensing electrode TSx or fingerprint sensing electrode FSx which intersects the receiving electrode Rx.

In addition, the via holes 330 are formed in some intersections which are required to constitute a network among intersections between the driving electrodes Tx of the driving/receiving electrode group 100 and the connection electrodes Cx in the bezel area BA. The via hole 330 of the bezel area BA electrically connects the driving electrode Tx of the first or second sub-driving/receiving electrode group 120 or 140 and the connection electrode Cx which correspond to each other.

FIG. 3 is an exploded cross-sectional view of a partial area of the active area of the touch screen panel according to an embodiment of the present invention.

Referring to FIGS. 2 and 3, the active area AA of the touch screen panel may be formed by sequentially stacking the driving/receiving electrode group 100, the insulating layer 300, the sensing electrode group 200, a transparent adhesive film 20, and glass 30 on a substrate 10. A first electrode group 100, the insulating layer 300, and a second electrode group 200 may be formed directly on glass and a film material which becomes a window for a mobile phone and a tablet. The driving/receiving electrode group 100 includes the driving electrodes Tx and the receiving electrodes Rx, and the receiving electrode Rx is illustrated in FIG. 3. The sensing electrode group 200 includes the touch sensing electrodes TSx and the fingerprint sensing electrodes FSx, and the touch sensing electrode TSx is illustrated in FIG. 3.

The driving/receiving electrode group 100 is disposed on the substrate 10. The substrate 10 may be a film, and the substrate 10 and the driving/receiving electrode group 100 may be transparent. The driving/receiving electrode group 100 may be made of a flexible material. In addition, the driving/receiving electrode group 100 may be made of a metal mesh, nanowires, indium tin oxide (ITO), or a composite material of the above materials. The driving/receiving electrode group 100 may be formed on the substrate 10 through an exposure etching or printing method.

According to an embodiment of the present invention, the driving/receiving electrode group 100 is formed as a plurality of electrodes having a line width of 10 μm to 200 μm. Advantageously, each electrode has a line width of 50 μm to 80 μm. In addition, a pitch between the electrodes of the driving/receiving electrode group 100 may be formed in a range of 20 μm to 400 μm. Advantageously, the pitch between the electrodes may be formed in a range of 80 μm to 200 μm.

The insulating layer 300 is disposed on the driving/receiving electrode group 100. The insulating layer 300 may be transparent and may be disposed through a lamination method or a printing method. The insulating layer 300 may be formed to have a thickness of several to several tens of micrometers using an insulating material. The insulating layer 300 may be formed through an exposure etching method or a printing method.

The sensing electrode group 200 is disposed on the insulating layer 300. The sensing electrode group 200 may be made of a flexible material. In addition, the sensing electrode group 200 may be made of a metal mesh, nanowires, ITO, or a composite material of the above materials. The sensing electrode group 200 may be formed through an exposure etching or printing method.

According to an embodiment of the present invention, the sensing electrode group 200 is formed as a plurality of electrodes having a line width of 10 μm to 200 μm. Advantageously, each electrode has a line width of 50 μm to 80 μm. In addition, a pitch between the electrodes of the sensing electrode group 200 may be formed in a range of 20 μm to 400 μm. Advantageously, the pitch between the electrodes may be formed in a range of 80 μm to 200 μm.

The optically transparent adhesive film (optically clear adhesive (OCA) film) 20 may be disposed on the sensing electrode group 200. The glass 30 may be disposed on the optically transparent adhesive film 20.

As shown in FIG. 3, the insulating layer 300 has the via holes 310 formed in the intersections which are required to constitute a network for transmitting a signal among the intersections between the receiving electrodes Rx of the driving/receiving electrode group 100 and the touch sensing electrodes TSx or the fingerprint sensing electrodes FSx of the sensing electrode group 200.

A connection portion is formed in the via holes 310 to electrically connect the receiving electrode Rx or the touch sensing electrode TSx or fingerprint sensing electrode FSx which intersects the receiving electrode Rx. Such a connection portion may be formed using a separate connection electrode. Alternatively, when the touch sensing electrode TSx or the fingerprint sensing electrode FSx is formed, a portion of the touch sensing electrode TSx or fingerprint sensing electrode FSx may be formed in the via hole 310 so that the touch sensing electrode TSx or the fingerprint sensing electrode FSx may be integrally formed with the connection portion.

The via hole 330 of the bezel area BA electrically connects the driving electrode Tx of the driving/receiving electrode group 100 or 140 and the connection electrode Cx which correspond to each other. The driving/receiving electrode group 100 is disposed on the substrate 10, and the connection electrode group 250 is disposed on the insulating layer 300. The transparent adhesive film 20 may be stacked and formed on the connection electrode group 250.

The connection electrode group 250 may be made of a metal mesh, nanowires, ITO, or a composite of the above materials. The connection electrode group 250 may be formed through an exposure etching or printing method. The connection electrode group 250 may be formed simultaneously when the sensing electrode group 200 is formed. Therefore, the connection electrode and the sensing electrode group may be formed of the same material through the same method.

According to an embodiment of the present invention, the connection electrode group 250 is formed as a plurality of connection electrodes having a line width of 10 μm to 200 μm. Advantageously, each electrode has a line width of 50 μm to 80 μm. In addition, a pitch between the electrodes of the connection electrode group 250 may be formed in a range of 20 μm to 400 μm. Advantageously, the pitch between the electrodes may be formed in a range of 80 μm to 200 μm.

In the present invention, the via holes 310 and 330 refer to via holes in which a separate connection portion or a portion of an electrode is disposed inside the hole to electrically connect two electrodes that intersect each other with the insulating layer 300 interposed therebetween.

Although the via holes 310 and 330 are illustrated in the drawing as having a tetragonal shape, the via holes 310 and 330 may have a shape such as a tetragonal shape, a circular shape, an oval shape, or a cross shape. In addition, a plurality of tetragonal, circular, oval, or cross-shaped holes may be disposed and formed.

Referring again to FIG. 2, each of the sub-driving/receiving electrode groups 120 and 140 of the driving/receiving electrode group 100 includes the plurality of driving electrodes Tx and the plurality of receiving electrodes Rx. The receiving electrode Rx may be disposed between the driving electrodes Tx.

The driving electrode Tx of the driving/receiving electrode group 100 is used for providing a driving pulse signal to the active area AA. The driving electrodes Tx are disposed to be parallel to the first direction. A driving pulse is applied directly to the driving electrode Tx of the first sub-driving/receiving electrode group 120, and the driving electrode TX of the second sub-driving/receiving electrode group 140 receives the driving pulse from the corresponding driving electrode Tx of the first sub-driving/receiving electrode group 120 through the corresponding connection electrode Cx.

The driving electrode Tx of the first sub-driving/receiving electrode group 120 and the driving electrode Tx of the second sub-driving/receiving electrode group 140 are formed in the same arrangement in a one-to-one correspondence relationship and are electrically connected through the connection electrode Cx.

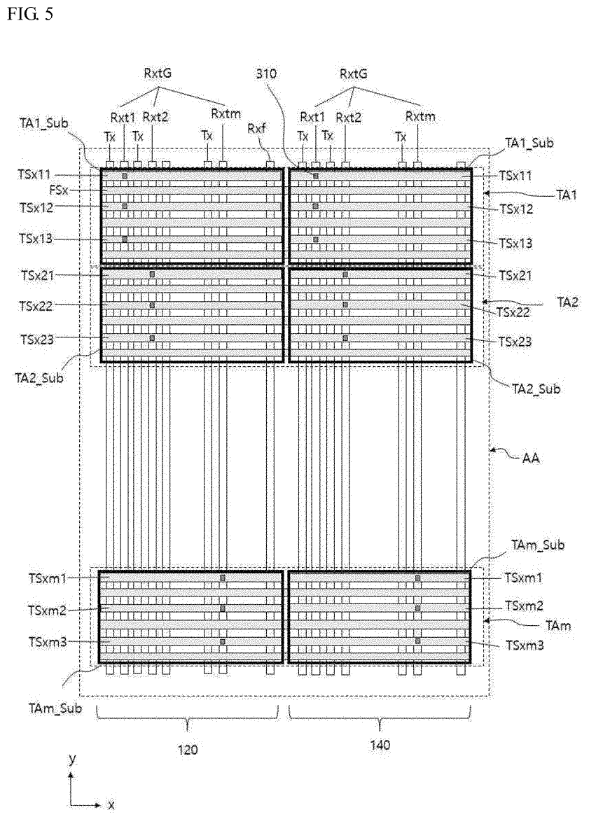

FIG. 4 is view for describing a connection relationship between driving electrodes Tx of a first sub-driving/receiving electrode group 120 and driving electrodes Tx of a second sub-driving/receiving electrode group 140 through connection electrodes Cx in a bezel area BA.

Referring to FIG. 4, the driving electrodes Tx of the first sub-driving/receiving electrode group 120 sequentially correspond to the driving electrodes Tx of the second sub-driving/receiving electrode group 140.

A first driving electrode Tx_11 of the first sub-driving/receiving electrode group 120 and a first driving electrode Tx_21 of the second sub-driving/receiving electrode group 140 correspond to each other and are connected to each other through a first connection electrode Cx_1. Since via holes 330 are formed in intersections between the first driving electrodes Tx_11 and Tx_21 of the first and second sub-driving-receiving electrode groups 120 and 140 and the first connection electrode Cx_1, when a driving pulse is applied to the first driving electrode Tx_11 of the first sub-driving/receiving electrode group 120, the driving pulse is transmitted to the first driving electrode Tx_21 of the second sub-driving/receiving electrode group 140 through the first connection electrode Cx_1. Thus, the first driving electrodes Tx_11 and Tx_21 of the first and second sub-driving/receiving electrode groups 120 and 140 simultaneously provide a driving pulse to an active area AA.

In addition, a second driving electrode Tx_12 of the first sub-driving/receiving electrode group 120 and a second driving electrode Tx_22 of the second sub-driving/receiving electrode group 140 correspond to each other and are connected to a second connection electrode Cx_2 through the via holes 330. Therefore, since a driving pulse applied to the second driving electrode Tx_12 of the first sub-driving/receiving electrode group 120 is transmitted to the second driving electrode Tx_22 of the second sub-driving/receiving electrode group 140 through the second connection electrode Cx_2, the second driving electrodes Tx_12 and Tx_22 simultaneously provide the driving pulse to the active area AA.

Therefore, a driving pulse is simultaneously applied to any one of the driving electrodes Tx of the first sub-driving/receiving electrode group 120 and any corresponding one of the driving electrodes Tx of the second sub-driving/receiving electrode group 140 connected thereto through the corresponding connection electrode Cx.

As shown in FIG. 2, in a driving/receiving electrode group 100, a receiving electrode Rx is disposed between the driving electrodes Tx. The receiving electrode Rx is an electrode which is used for transmitting a signal to a controller 400 disposed in the bezel area BA so as to constitute a network. The receiving electrodes Rx are electrically connected to touch sensing electrodes TSx or fingerprint sensing electrodes FSx through via holes 310 at intersections with the touch sensing electrodes TSx or the fingerprint sensing electrodes FSx. Thus, the receiving electrode Rx receives a charge quantity change signal generated at an intersection between the driving electrode Tx and the touch sensing electrode TSx or between the driving electrode Tx and the fingerprint sensing electrode FSx and provides the received charge quantity change signal to the controller 400.

Among a plurality of receiving electrodes Rx, the receiving electrodes Rx connected to the touch sensing electrodes TSx through the via holes 310 are touch receiving electrodes for receiving a touch signal. Among the plurality of receiving electrodes Rx, the receiving electrodes connected to the fingerprint sensing electrodes FSx through the via holes 310 are fingerprint receiving electrodes for receiving a fingerprint signal.

According to an embodiment of the present invention, the driving/receiving electrode group 100 may include dummy electrodes Dx. The dummy electrode Dx may be disposed between the driving electrodes Tx. The dummy electrode Dx refers to an electrode which is not electrically connected to the touch sensing electrode TSx and the fingerprint sensing electrode FSx. In the driving/receiving electrode group 100, among electrodes between the driving electrodes Tx, the remaining electrodes excluding the receiving electrodes Rx form the dummy electrodes Dx. According to a standard of a touch screen panel, all electrodes of the driving/receiving electrode group 100 may be used as the driving electrodes Tx and the receiving electrodes Rx, and in this case, the dummy electrode Dx may not be formed. In the driving/receiving electrode group 100, the driving electrode Tx, the receiving electrode Rx, and the dummy electrode Dx may be functionally divided according to a connection relationship with the controller 400 and may be formed to have the same shape and width.

Meanwhile, in the embodiment shown in FIG. 2, a case is described in which the receiving electrodes Rx or the dummy electrodes Dx are alternately disposed one by one between the driving electrodes Tx in the driving/receiving electrode group 100, but the present invention is not limited thereto. A plurality of electrodes may be disposed between the adjacent driving electrodes Tx, and the plurality of electrodes between the driving electrodes Tx may be the receiving electrodes Rx or the dummy electrodes Dx. The driving electrodes Tx may be disposed at uniform intervals, and the receiving electrode Rx or the dummy electrode Dx may be disposed therebetween.

A sensing electrode group 200 includes a plurality of touch sensing electrode rows TSxR and the plurality of fingerprint sensing electrodes FSx.

The touch sensing electrode row TSxR includes each touch sensing electrode TSx corresponding to each of the sub-driving/receiving electrode groups 120 and 140. Accordingly, the touch sensing electrodes are formed to correspond to each of the first and second sub-driving/receiving electrode groups 120 and 140. The touch sensing electrode TSx is an electrode used for sensing a touch signal. Each of the touch sensing electrodes TSx is electrically connected to a touch receiving electrode Rxt in each of the sub-driving/receiving electrode groups 120 and 140 through the via hole 310.

The fingerprint sensing electrode FSx is an electrode used for sensing a fingerprint signal according to a fingerprint touch and is disposed between the touch sensing electrode rows TSxR. The fingerprint sensing electrode extends to intersect the sub-driving/receiving electrode group. The fingerprint sensing electrodes FSx are electrically connected to corresponding fingerprint receiving electrodes Rxf through the via holes 310. The fingerprint receiving electrode Rxf may be selected irrespective of the sub-driving/receiving electrode groups 120 and 140. Some of the fingerprint receiving electrodes may belong to the first sub-driving/receiving electrode group, and others thereof may belong to the second sub-driving/receiving electrode group.

When the active area AA is formed such that fingerprint sensing is possible in an entire area of the active area AA, the fingerprint sensing electrodes FSx are disposed in the entire active area AA and are electrically connected to the fingerprint receiving electrodes, which are used for receiving a fingerprint signal among the receiving electrodes Rx, through the via holes 310.

When a fingerprint sensing area is formed such that fingerprint sensing is possible only in a portion of the active area AA, the plurality of fingerprint sensing electrodes FSx may be disposed in the fingerprint sensing area, and dummy sensing electrodes may be formed between the touch sensing electrode rows TSxR disposed outside the fingerprint sensing area. In the present invention, it is not excluded that the dummy sensing electrodes are formed between the touch sensing electrode rows TSx. The dummy sensing electrode refers to an electrode which is not electrically connected to the receiving electrode.

Each of the touch sensing electrode TSx and the fingerprint sensing electrode FSx is used for detecting a touch signal or a fingerprint signal by detecting a change in capacitance appearing at an intersection with the driving electrode Tx.

According to an embodiment of the present invention, the bezel area BA may be formed at one side of the active area AA in a first direction that is an extending direction of the driving/receiving electrode group 100.

The controller 400 is disposed in the bezel area BA, and a pad is formed at each of the driving electrodes of the first sub-driving/receiving electrode group 100 and connected to the controller 400. The controller 400 provides a driving pulse signal to the driving electrode Tx of the first sub-driving/receiving electrode group. In addition, pads are also formed at an end portion of each touch receiving electrode and at each fingerprint receiving electrode and connected to the controller 400. The controller 400 detects a touch from a signal received through the touch receiving electrode in a touch sensing mode and detects a fingerprint from a signal received through the fingerprint receiving electrode in a fingerprint sensing mode.

According to a touch screen panel according to an embodiment of the present invention, the driving electrode is commonly used for providing a driving signal in the touch sensing mode and the fingerprint sensing mode.

According to an exemplary embodiment of the present invention, the bezel area BA may be formed on a flexible substrate (FPCB) so as to be disposed at one side in the first direction. However, for example, it is not excluded that a component for applying a driving pulse to a connection electrode group 250 and the driving electrode is formed at one side of the active area AA in the first direction and a component for receiving a sensing signal through the touch receiving electrode and the fingerprint receiving electrode is formed at the other side of the active area AA in the first direction. However, when the bezel area BA is formed only in one direction, that is, in the first direction, it is more advantageous to minimize the bezel area BA and to form a bezel-free front side of a display. The touch screen panel according to the embodiment of the present invention makes it possible to form the bezel area BA at only one side of the active area AA.

FIG. 5 is a plan view illustrating a connection relationship between touch sensing electrodes and touch receiving electrodes in a touch screen panel according to an embodiment of the present invention.

In FIG. 5, for illustrative clarity, a connection relationship between fingerprint receiving electrodes Rxf and fingerprint sensing electrodes FSx is omitted, and only a connection relationship between some touch sensing electrodes TSx and corresponding touch receiving electrodes Rxt is illustrated. The touch receiving electrodes Rxt are receiving electrodes which are allocated to receive a touch signal among receiving electrodes Rx.

The touch screen panel according to the present invention includes touch receiving electrode groups RxtG each including the plurality of touch receiving electrodes Rxt. Touch receiving electrodes Rxt1, Rxt2, and Rxtm are formed to correspond to each of the sub-driving/receiving electrode groups 120 and 140. Accordingly, the touch receiving electrode group is formed to correspond to each of the sub-driving/receiving electrode groups 120 and 140.

The number of the plurality of touch receiving electrodes Rxt1, Rxt2, and Rxtm constituting the touch receiving electrode group RxtG corresponds to the number of touch sensing areas TA1, TA2, and TAm.

An active area AA of the touch screen panel according to the embodiment of the present invention includes the plurality of touch sensing areas TA1, TA2, and TAm which are parallel to a second direction (x-direction). The touch sensing areas TA1, TA2, and TAm respectively include sub-touch sensing areas TA1_Sub, TA2_Sub, and TAm_Sub corresponding to the sub-driving/receiving electrode groups 120 and 140.

For example, referring to FIG. 5, a first touch sensing area TA1 includes two sub-touch sensing areas TA1_Sub at both left and right sides so as to correspond to first and second sub-driving/receiving electrode groups 120 and 140.

Each of the touch sensing areas TA1, TA2, and TAm includes a plurality of touch sensing electrode rows, and the sub-touch sensing areas TA1_Sub, TA2_Sub, and TAm_Sub include a plurality of touch sensing electrodes TSx11, TSx12, TSx13, a plurality of touch sensing electrodes TSx21, TSx22, and TSx23, and a plurality of touch sensing electrodes TSxm1, TSxm2, and TSxm3. As described with reference to FIG. 2, the touch sensing electrode row is defined as a group of the plurality of touch sensing electrodes disposed in a line.

The touch receiving electrode group RtxG is a group of the touch receiving electrodes connected to the plurality of sub-touch sensing areas TA1_Sub, TA2_Sub, and TAm_Sub which intersect the sub-driving/receiving electrode group, to which the touch receiving electrode group RtxG belongs, and are parallel to a first direction. Each touch receiving electrode Rxt of the touch receiving electrode group RtxG corresponds to each sub-touch sensing area TA1_Sub, TA2_Sub, or TAm_Sub. FIG. 5 schematically illustrates only some of the touch sensing area rows and only some of the sub-touch sensing areas.

The plurality of touch sensing electrodes TSx11, TSx12, and TSx13, the plurality of touch sensing electrodes TSx21, TSx22, and TSx23, or the plurality of touch sensing electrodes TSxm1, TSxm2, and TSxm3 disposed in one sub-touch sensing area TA1_Sub, TA2_Sub, or TAm_Sub are commonly connected to one touch receiving electrode Rxt1, Rxt2, or Rxtm. Accordingly, each of the sub-touch sensing areas TA1_Sub, TA2_Sub, and TAm_Sub is connected to one of the touch receiving electrodes Rxt1, Rxt2, and Rxtm of the touch receiving electrode group in a one-to-one correspondence relationship.

For example, the plurality of touch sensing electrodes TSx11, TSx12, and TSx13 disposed in the left sub-touch sensing area TA1_Sub of a row of the first touch sensing area TA1 intersecting the first sub-driving/receiving electrode group 120 are commonly connected to a first touch receiving electrode Rxt1 of the first sub-driving/receiving electrode group 120. FIG. 5 illustrates that via holes 310 are formed at intersections between the first touch receiving electrode Rxt1 and the plurality of touch sensing electrodes TSx11, TSx12, and TSx13 so that the first touch receiving electrode Rxt1 and the plurality of touch sensing electrodes TSx11, TSx12, and TSx13 are connected.

In addition, the plurality of touch sensing electrodes TSx21, TSx22, and TSx23 disposed in the left sub-touch sensing area TA2_Sub of a row of a second touch sensing area TA2 intersecting the first sub-driving/receiving electrode group 120 are commonly connected to a second touch receiving electrode Rxt2 of the first sub-driving/receiving electrode group 120 through the via holes 310.

Furthermore, the plurality of touch sensing electrodes TSxm1, TSxm2, and TSxm3 disposed in the left sub-touch sensing area TAm_Sub of a row of an m^{th} touch sensing area TAm intersecting the first sub-driving/receiving electrode group 120 are commonly connected to an m^{th} touch receiving electrode Rxtm of the first sub-driving/receiving electrode group 120 through the via holes 310.

Meanwhile, the plurality of touch sensing electrodes TSx11, TSx12, and TSx13 disposed in the right sub-touch sensing area TA1_Sub of the row of the first touch sensing area TA1 intersecting the second sub-driving/receiving electrode group 140 are commonly connected to a first touch receiving electrode Rxt1 of the second sub-driving/receiving electrode group 140. In addition, the plurality of touch sensing electrodes TSx21, TSx22, and TSx23 and the plurality of touch sensing electrodes TSxm1, TSxm2, and TSxm3 disposed in the right sub-touch sensing areas TA2_Sub and TAm_Sub of the rows of the second and m^{th} touch sensing areas TA2 and TAm intersecting the second sub-driving/receiving electrode group 140 are commonly connected to second and m^{th} touch receiving electrodes Rxt2 and Rxtm of the second sub-driving/receiving electrode group 140 through the via holes 310, respectively.

One touch receiving electrode Rxt1, Rxt2, or Rxtm is allocated to correspond to one sub-touch sensing area TA1_Sub, TA2_Sub, or TAm_Sub, and the plurality of touch sensing electrodes TSx11, TSx12, and TSx13, the plurality of touch sensing electrodes TSx21, TSx22, and TSx23, or the plurality of touch sensing electrodes TSxm1, TSxm2, and TSxm3 in each sub-touch sensing area TA1_Sub, TA2_Sub, or TAm_Sub are commonly and electrically connected to one touch receiving electrode Rxt1, Rxt2, or Rxtm. The plurality of touch sensing electrodes in each sub-touch sensing area are electrically grouped into one to serve as one electrode. Therefore, even when the touch sensing electrode is formed as a microchannel electrode, it is possible to prevent touch sensing sensitivity from degrading.

In the embodiment illustrated in the drawing, each of the touch sensing areas TA1, TA2, and TAm is illustrated as including three touch sensing electrode rows, but this is merely an example for description. The number of the touch sensing areas and the number of the touch sensing electrode rows constituting the touch sensing area are determined in consideration of the width and pitch of the touch sensing electrodes. In addition, a number m of the touch sensing areas is also determined according to the standard and size of a screen panel. In addition, in a touch screen panel in which touch sensing and fingerprint sensing are performed at the same time, the length of the touch sensing electrode is determined by the width of the sub-fingerprint sensing area (length in the second direction).

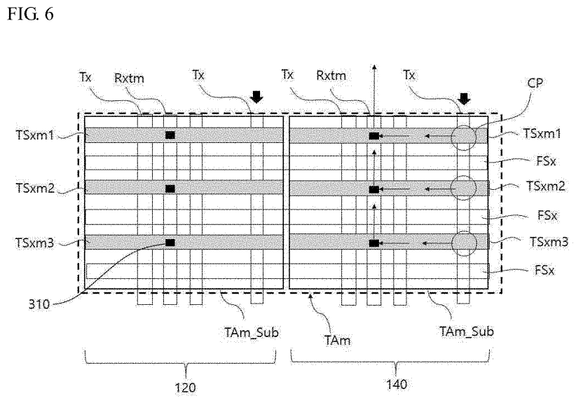

FIG. 6 is a view for describing an operation of a touch sensing mode in a touch screen panel according to an embodiment of the present invention. For illustrative clarity, some driving electrodes Tx, a corresponding touch sensing area TAm, a sub-touch sensing area Tam_Sub, and a corresponding touch receiving electrode Rxtm are illustrated, and the remaining components are omitted.

Referring to FIG. 6, driving pulses (indicated by a thick arrow) are simultaneously applied to one driving electrode Tx of a first sub-driving/receiving electrode group 120 and one driving electrode Tx of a second sub-driving/receiving electrode group 140 corresponding thereto. In this case, assuming that a user touch is sensed at intersections indicated by a circle and denoted by CP, since there is no change in capacitance in the left sub-touch sensing area TAm_Sub of the touch sensing area TAm corresponding to the first sub-driving/receiving electrode group 120, touch information is not received. However, in the right sub-touch sensing area TAM_Sub of the touch sensing area TAM corresponding to the second sub-driving/receiving electrode group 140, a change in capacitance occurs according to a touch at intersections CP between a plurality of touch sensing electrodes TSxm1, TSxm2, and TSxm3 of the right touch sensing area TAM_Sub and the driving electrode Tx to which a driving pulse is applied. A corresponding touch signal is transmitted through each of the touch sensing electrode TSxm1, TSxm2, and TSxm3 and transmitted to a connected corresponding receiving electrode Rxtm of the second sub-driving/receiving electrode group 140 from intersections between an m^{th} receiving electrode Rxtm and the touch sensing electrodes TSxm1, TSxm2, and TSxm3 through via holes 310. A controller detects whether a touch occurs and a position of the touch from a signal received from the corresponding receiving electrode Rxtm.

Driving pulses are simultaneously applied to the corresponding driving electrodes of the sub-touch sensing areas TAm_Sub. However, a touch receiving electrode corresponding to each of the sub-touch sensing areas TAm_Sub is provided, and thus, a signal is received for each of the sub-touch sensing areas TAm_Sub, thereby sensing a position of a touch. A touch signal generated at an intersection with a specific driving electrode Tx in each of the sub-touch sensing areas TAM_Sub is transmitted to a controller 400 through a corresponding one of the receiving electrodes Rxtm.

According to embodiments, in the touch sensing mode, the plurality of driving electrodes Tx of the first sub-driving/receiving electrode group may be grouped into one group to functionally serve as one driving electrode. The plurality of driving electrodes Tx being grouped into one group to functionally serve as one driving electrode means that signals are simultaneously applied to the plurality of driving electrodes grouped into one group. When the plurality of driving electrodes Tx of the first sub-driving/receiving electrode group are grouped to serve as one driving electrode, the plurality of corresponding driving electrodes Tx of the second sub-driving/receiving electrode group may also serve as one driving electrode.

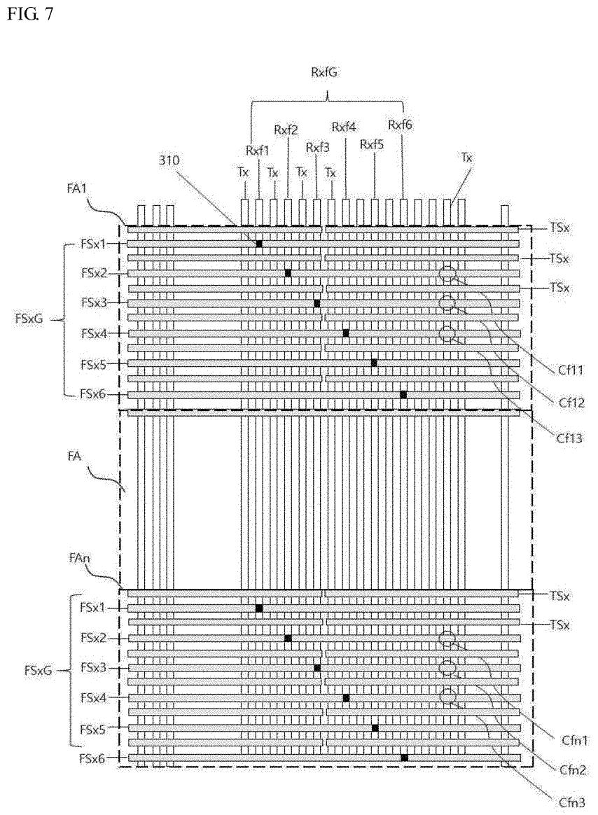

FIG. 7 is a plan view for describing a connection relationship between fingerprint sensing electrodes and fingerprint receiving electrodes in a touch screen panel according to an embodiment of the present invention.

Referring to FIG. 7, an active area AA of the touch screen panel includes a plurality of fingerprint sensing areas FA1, FA, and FAn parallel to a second direction. For illustrative clarity, FIG. 7 illustrates only some fingerprint sensing areas FA1, FA, and FAn. When the plurality of fingerprint sensing areas are formed, the fingerprint sensing areas are formed adjacent to each other in a first direction. In FIG. 7, in order to avoid confusion, only a connection relationship between fingerprint sensing electrodes FSx and fingerprint receiving electrodes Rxf is illustrated in some fingerprint sensing areas, and a connection relationship between touch sensing electrodes TSx and touch receiving electrodes Rxt is omitted. The fingerprint receiving electrodes Rxf correspond to receiving electrodes allocated to receive a fingerprint signal among receiving electrodes Rx and form a fingerprint receiving electrode group RxfG.

The fingerprint sensing areas FA1, FA, and FAn may be divided into sub-fingerprint sensing areas FA1_Sub, FA_Sub, and FAn_Sub so as to correspond to sub-driving/receiving electrode groups. Each of the sub-fingerprint sensing areas FA1_Sub, FA_Sub, and FAn_Sub is formed to be greater than a fingerprint size of a human being.

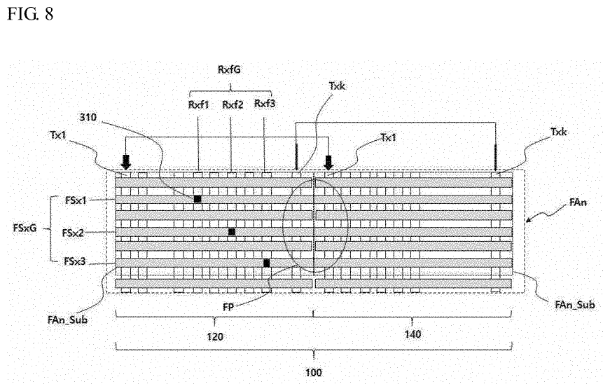

Each of the fingerprint sensing areas being divided into sub-fingerprint sensing areas will be described with reference to FIG. 8. First, a connection relationship between the fingerprint sensing areas FA1, FA, and FAn and the fingerprint sensing electrodes will be described with reference to FIG. 7.

Each of the fingerprint sensing areas FA1, FAn, and FA includes a fingerprint sensing electrode group FSxG including a plurality of fingerprint sensing electrodes FSx1, FSx2, FSx3, FSx4, FSx5, and FSx6. Each of the fingerprint sensing areas FA1, FAn, and FA includes the fingerprint receiving electrode group RxfG including a plurality of fingerprint receiving electrodes Rxf1, Rxf2, Rxf3, Rxf4, Rxf5, and Rxf6 which respectively correspond to the fingerprint sensing electrodes FSx1, FSx2, FSx3, FSx4, FSx5, and FSx6 of the fingerprint sensing electrode group FSxG The number of the fingerprint receiving electrodes Rxf1, Rxf2, Rxf3, Rxf4, Rxf5, and Rxf6 constituting the fingerprint receiving electrode group RxfG corresponds to the number of the fingerprint sensing electrodes constituting the fingerprint sensing area. FIG. 7 illustrates that some of the fingerprint receiving electrodes of the fingerprint receiving electrode group RxfG are positioned in a first sub-driving/receiving electrode group 120 and the others thereof are positioned in a second sub-driving/receiving electrode group 140, but this is merely an example. Fingerprint receiving electrodes Rxf may be selected within a driving/receiving electrode group 100 intersecting the fingerprint sensing area irrespective of the sub-driving/receiving electrode group. In addition, in the embodiment illustrated in the drawing, the fingerprint sensing electrode group FSxG is illustrated as including six fingerprint sensing electrodes FSx1, FSx2, FSx3, FSx4, FSx5, and FSx6, but this is merely an example for description.

The fingerprint sensing electrode group FSxG includes an appropriate number of the fingerprint sensing electrodes so as to detect a fingerprint in contact with the fingerprint sensing area. The fingerprint receiving electrode group RxfG includes the number of the fingerprint receiving electrodes Rxf which corresponds to the number of the fingerprint sensing electrodes constituting the fingerprint sensing electrode group FSxG.

The fingerprint sensing electrodes FSx1, FSx2, FSx3, FSx4, FSx5, and FSx6 of the fingerprint sensing electrode group FSxG in the fingerprint sensing area FA1 or FAn are connected at intersections with the fingerprint receiving electrodes Rxf1, Rxf2, Rxf3, Rxf4, Rxf5, and Rxf6 of the fingerprint receiving electrode group RxfG through via holes 310, respectively.

The fingerprint sensing electrode groups FSxG forming the fingerprint sensing areas FA1 and FAn are commonly connected to the fingerprint receiving electrode group RxfG That is, a connection pattern between one fingerprint sensing area and the fingerprint receiving electrodes is the same as a connection pattern between another fingerprint sensing area and the fingerprint receiving electrodes.

For example, regarding a connection relationship between the fingerprint sensing electrode group FSxG and the fingerprint receiving electrode group RxfG in a first fingerprint sensing area FA1, a first fingerprint sensing electrode FSx1 is connected at an intersection with a first fingerprint receiving electrode Rxf1 through the via hole 310, and a second fingerprint sensing electrode FSx2 is connected at an intersection with a second fingerprint receiving electrode Rxf2 through the via hole 310. In the same manner, third, fourth, fifth, and sixth fingerprint sensing electrodes FSx3, FSx4, FSx5, and FSx6 are respectively connected to third, fourth, fifth, and sixth fingerprint receiving electrodes Rxf3, Rxf4, Rxf5, and Rxf6 through the via holes 31.

In addition, a first fingerprint sensing electrode FSx1 of an n^{th} fingerprint sensing area FAn is connected through the first fingerprint receiving electrode Rxf1 through the via hole 310, and a second fingerprint sensing electrode FSx2 thereof is connected to the second fingerprint receiving electrode Rxf2 through the via hole 310. In the same manner, third, fourth, fifth, and sixth fingerprint sensing electrodes FSx3, FSx4, FSx5, and FSx6 of the n^{th} fingerprint sensing area FAn are respectively connected to the third, fourth, fifth, and sixth fingerprint receiving electrodes Rxf3, Rxf4, Rxf5, and Rxf6 through the via holes 310.

As described above, since the fingerprint receiving electrode group RxfG is commonly connected to the fingerprint sensing areas FA1 and FAn, a connection pattern between each of the fingerprint sensing electrodes and each of the fingerprint receiving electrodes in one fingerprint sensing area is repeated even in a connection pattern between each of the fingerprint sensing electrodes and the fingerprint receiving electrode in another fingerprint sensing area. Therefore, the fingerprint receiving electrodes of the fingerprint receiving electrode group RxfG receive information of each of the fingerprint sensing areas in an overlapping manner.

For example, assuming that a fingerprint touch occurs in areas Cf11, Cf12, and Cf13 which are intersections between driving electrodes Tx and the fingerprint sensing electrodes FSx2, FSx3, and FSx4 in the first fingerprint sensing area FA1, fingerprint information in the areas Cf11, Cf12, and Cf13 is detected through the second, third, and fourth fingerprint sensing electrodes FSx2, FSx3, and FSx4, is transferred to the second, third, and fourth fingerprint receiving electrodes Rxf2, Rxf3, and Rxf4 through the via holes 310, and is input to a controller and processed.

As another case, assuming that a fingerprint touch occurs in areas Cfn1, Cfn2, and Cfn3 which are intersections between the driving electrodes Tx and the fingerprint sensing electrodes FSx2, FSx3, and FSx4 in the n^{th} fingerprint sensing area FAn, a signal in the corresponding intersections is detected through the second, third, and fourth fingerprint sensing electrodes FSx2, FSx3, and FSx4, passes through the second, third, and fourth fingerprint receiving electrodes Rxf2, Rxf3, and Rxf4 through the via holes 310, and is input to the controller and processed.

In a fingerprint sensing mode, when a signal is applied to the driving electrodes Tx with a time-related phase difference, a signal generated at the intersection between each of the driving electrodes and each of the fingerprint sensing electrodes passes through each fingerprint sensing electrode and is input to a controller 400 through each of the fingerprint receiving electrodes. Thus, a fingerprint is determined.

When a fingerprint is sensed, irrespective of whether a user's fingerprint touch is performed on the first fingerprint sensing area or another n^{th} fingerprint sensing area, only the fingerprint itself needs to be sensed. This is because, in terms of fingerprint sensing, there is no need to discriminate in which fingerprint sensing area a fingerprint touch occurs. As described above, since the fingerprint sensing areas commonly use the fingerprint receiving electrodes, it is possible to minimize the number of channels of the fingerprint receiving electrodes and also sense a fingerprint in the entire active area AA including the plurality of fingerprint sensing areas.

FIG. 8 is a view for describing that each fingerprint sensing area is divided into a plurality of sub-fingerprint sensing areas so as to correspond to sub-driving/receiving electrode groups.

Referring to FIG. 8, an n^{th} fingerprint sensing area is divided into left and right sub-fingerprint sensing areas FAn_Sub so as to correspond to sub-driving/receiving electrode groups 120 and 140. Each of the fingerprint receiving electrodes Rxf1, Rxf2, and Rxf3 of a fingerprint receiving electrode group RxfG is connected to one of the fingerprint sensing electrodes FSx1, FSx2, and FSx3 of the n^{th} fingerprint sensing area through a via hole 310.

According to an embodiment of the present invention, driving electrodes Tx of a left sub-driving/receiving electrode group and driving electrodes Tx of a right sub-driving/receiving electrode group sequentially correspond to each other and are connected through connection electrodes in a bezel area BA. Therefore, when a driving pulse is applied to a first driving electrode Tx1 of a first driving/receiving electrode group, the driving pulse is simultaneously applied to a first driving electrode Tx1 of a second driving/receiving electrode group. In the same manner, when a driving pulse is applied to a k^{th} driving electrode Txk of the first driving/receiving electrode group, the driving pulse is simultaneously applied to a k^{th} driving electrode Txk of the second driving/receiving electrode group.

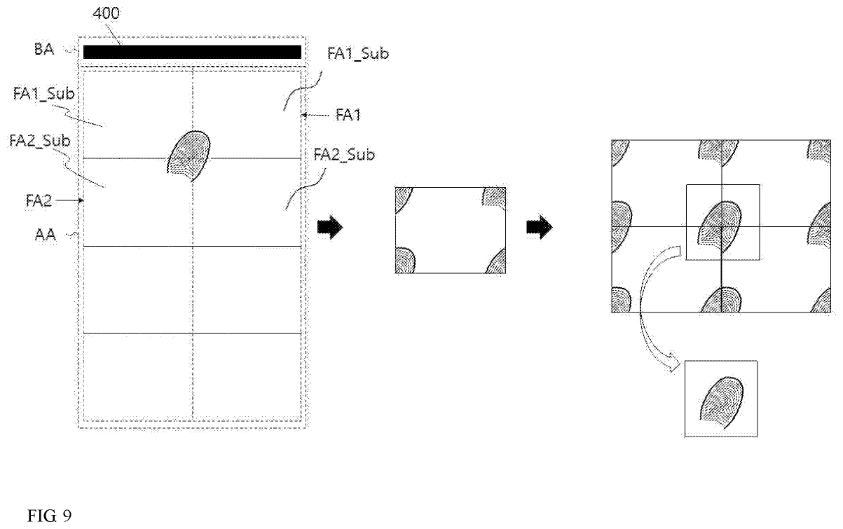

Since the fingerprint sensing electrodes FSx1, FSx2, and FSx3 extend to intersect sub-driving/receiving electrode groups 120 and 140, information of each sub-fingerprint sensing area is received in an overlapping manner. In this case, since each of the sub-fingerprint sensing areas is formed to be greater than a fingerprint size of a human being, fingerprint sensing is possible. For example, assuming that FP in FIG. 8 denotes a portion at which a fingerprint touch of a user occurs, when a driving pulse is simultaneously applied to the first driving electrodes Tx1 of the first and second sub-driving/receiving electrode groups 120 and 140, each of the fingerprint sensing electrodes FSx1, FSx2, and FSx3 of a fingerprint sensing electrode group FSxG senses fingerprint information in the right sub-fingerprint sensing area FAn_Sub corresponding to the second sub-driving/receiving electrode group 140. Subsequently, when a driving pulse is simultaneously applied to the k^{th} driving electrodes Txk of the first and second sub-driving/receiving electrode groups, the fingerprint receiving electrode group senses fingerprint information in the left sub-fingerprint sensing area FAn_Sub corresponding to the first sub-driving/receiving electrode group 120. When a fingerprint is sensed, there is no need to discriminate positions of the sub-fingerprint sensing area FAn_Sub like a case in which there is no need to discriminate positions of the fingerprint sensing area. Only the fingerprint itself needs to be sensed. A controller 400 receives pieces of divided fingerprint information through the fingerprint receiving electrode group RxfG and recognizes a fingerprint by combining the pieces of received divided fingerprint information. A procedure of recognizing a fingerprint will be described with reference to FIG. 9.

FIG. 9 illustrates a case in which a fingerprint touch occurs over four adjacent sub-fingerprint sensing areas and an example of a procedure of recognizing a fingerprint according to the fingerprint touch.

For example, a fingerprint touch occurs over two adjacent fingerprint sensing areas FA1 and FA2, and each of the fingerprint sensing areas includes left and right sub-fingerprint sensing areas FA1_Sub and FA2_Sub. Since a fingerprint receiving electrode group receives fingerprint touch information of each of the fingerprint sensing areas in an overlapping manner and each of the fingerprint sensing areas receives fingerprint touch information of each of the sub-fingerprint sensing areas in an overlapping manner, the fingerprint information is divided into four pieces and received (see the intermediate drawing). Fingerprint sensing information received by a fingerprint receiving electrode group RxfG is received irrespective of positions of the fingerprint sensing area and the sub-fingerprint sensing area.

According to an embodiment of the present invention, a controller 400 arranges a plurality of pieces of received fingerprint information. Since each of the sub-fingerprint sensing areas is formed to be greater than a fingerprint size of a human being, in the present embodiment, fingerprint information may be divided into up to four areas. Therefore, pieces of received fingerprint information may be arranged in the form of a 2×2 matrix, and information occupying the largest area can be sensed as fingerprint information (see the right drawing). A method of reconstituting divided fingerprint patterns and sensing the reconstituted fingerprint patterns as one fingerprint is not limited to the above description, and various methods may be used.

Meanwhile, although FIG. 7 illustrates a case in which a fingerprint sensing area is formed over the entire active area of the touch screen panel, the fingerprint sensing area may be formed only in a portion of the active area AA. For example, when fingerprint sensing on a touch screen is performed on only a lower side of the touch screen, a plurality of fingerprint sensing areas may be formed at the lower side of the touch screen.

In addition, in the present invention, it is not excluded that one fingerprint sensing area is formed. When one fingerprint sensing area is formed, a fingerprint receiving electrode group receives fingerprint information from a fingerprint sensing electrode group in one fingerprint sensing area. In this case, the fingerprint receiving electrode group receives only fingerprint sensing information of a plurality of sub-fingerprint sensing areas constituting one fingerprint sensing area in an overlapping manner. In this case, in an active area outside the fingerprint sensing area of a touch screen panel, a dummy sensing electrode may be disposed between touch sensing electrode rows.

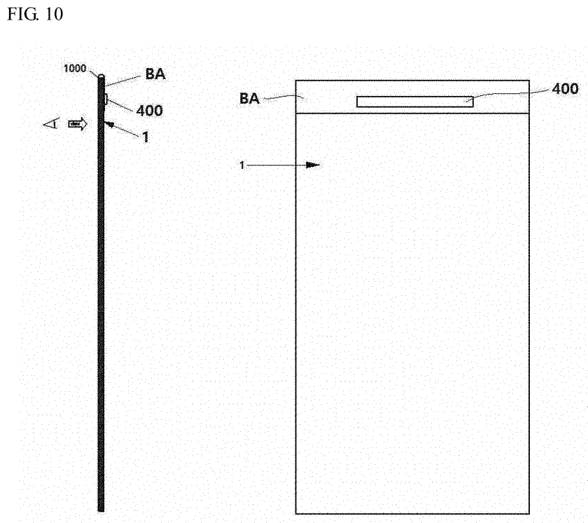

FIG. 10 shows schematic views illustrating a touch screen to which a touch screen panel is applied according to the present invention in which a right view is a side view of the touch screen, and a left view is a rear view. According to an embodiment of the present invention, the touch screen panel may be formed to be flexible such that at least a bezel area is foldable.

Since the touch screen panel according to the embodiment of the present invention uses some electrodes disposed in a driving/receiving electrode group 100 as receiving electrodes Rx, a bezel area BA may be formed in a single direction that is an extending direction of the driving/receiving electrode group 100. Accordingly, when the bezel area BA is formed to be foldable, the bezel area BA may be folded and disposed on a rear side of a display 1.

Therefore, when viewed from a front side of the display 1, a bezel-free display can be formed. The bezel area BA and a controller 400 are disposed on the rear side of the display.

In addition, even when the bezel area BA is disposed without being folded, the bezel area BA may be disposed only at one side in a first direction, thereby minimizing the bezel area disposed on the front side of the display.

The drawing of FIG. 10 illustrates a case in which the bezel area is formed at one side in the first direction (y-direction in the drawing), but even when the bezel area is formed at both sides in the first direction, it is possible to achieve a bezel-free display by folding both bezel areas.

According to the present invention, since an electrode disposed parallel to a driving electrode is used as a receiving electrode, a bezel area can be formed in an extending direction of the driving electrode. Thus, it is possible to eliminate a bezel area BA formed outside an active area in an extending direction of a sensing electrode for a connection line connected to the sensing electrode, thereby minimizing a bezel area in a display to which a fingerprint sensor-integrated touch screen panel is applied.

In addition, according to the present invention, some driving electrodes are connected to other driving electrodes to simultaneously provide a driving pulse, thereby minimizing the number of channels to which the driving pulse is applied.

Furthermore, when a flexible material is applied to each electrode and an insulating layer, the electrode and the insulating layer can be applied to a foldable product, and when the electrode and the insulating layer are applied to a display, the bezel area can be folded on a rear side of the display. Accordingly, it is possible to form a bezel-free front side of the display.

In addition, according to the present invention, since sensing electrodes disposed to intersect driving electrodes are used as a touch sensing electrode and a fingerprint sensing electrode, touch sensing and fingerprint sensing are possible. Furthermore, when an active area is divided into a plurality of fingerprint sensing areas and a fingerprint sensing signal in each fingerprint sensing area is received as an overlapping signal through a fingerprint receiving electrode group, it is possible to minimize the number of receiving electrodes for transferring fingerprint sensing information to a controller, that is, the number of channels for transmitting a fingerprint sensing signal. In addition, fingerprint sensing is possible in an entire active area.

The protection scope of the claims of the present invention is not limited to the disclosure and expressions of the embodiments clearly described above. In addition, the protection scope of the present invention is not limited by modifications and substitutions obvious to the technical field to which the present invention pertains.

[Descriptions of Reference Numerals]

| | |
|---|---|
| 100: driving/receiving electrode | 200: sensing electrode |
| group | group |
| 300: insulating layer | 310, 330: via hole |
| 400: controller | |
| AA: active area | BA: bezel area |
| Tx: driving electrode | Rx: receiving electrode |
| TSx: touch sensing electrode | FSx: fingerprint sensing |
| | electrode |
| Dx: dummy electrode | TA: touch sensing area |
| FA: fingerprint sensing area | |

What is claimed is:

1. A fingerprint sensor-integrated touch screen panel comprising:
a driving/receiving electrode group which includes a plurality of sub-driving/receiving electrode groups, wherein each of the sub-driving/receiving electrode groups includes a plurality of driving electrodes and a plurality of receiving electrodes disposed to be parallel to a first direction;
a sensing electrode group which includes a plurality of touch sensing electrode rows and a plurality of fingerprint sensing electrodes and forms an active area, wherein the plurality of touch sensing electrode rows and the plurality of fingerprint sensing electrodes are disposed in a second direction intersecting the first direction to intersect the driving/receiving electrode group, and wherein touch sensing electrodes corresponding to the sub-driving/receiving electrode groups are disposed in a line in the touch sensing electrode row;
a connection electrode group which is formed at one side of the sensing electrode group in the first direction, includes a plurality of connection electrodes disposed to be parallel to the second direction so as to intersect the driving/receiving electrode group, and forms a bezel area; and
an insulating layer which is disposed between the driving/receiving electrode group and the sensing electrode group and between the driving/receiving electrode group and the connection electrode group and has via holes formed in some intersections between the receiving electrodes and the touch and fingerprint sensing electrodes and some intersections between the driving electrodes of the driving/receiving electrode group and the connection electrodes.

2. The fingerprint sensor-integrated touch screen panel of claim 1, wherein, in the driving/receiving electrode group, the receiving electrode is disposed between the driving electrodes.

3. The fingerprint sensor-integrated touch screen panel of claim 2, wherein the driving/receiving electrode group includes a dummy electrode which is disposed between the driving electrodes and is not connected to the touch sensing electrode and the fingerprint sensing electrode.

4. The fingerprint sensor-integrated touch screen panel of claim 1, wherein each of the electrodes of the driving/receiving electrode group has a line width of 10 μm to 200 μm and a pitch of 20 μm to 400 μm.

5. The fingerprint sensor-integrated touch screen panel of claim 1, wherein the driving electrodes of the sub-driving/receiving electrode group at one side and the driving electrodes of the sub-driving/receiving electrode group at the other side are formed in the same arrangement so as to sequentially correspond to each other and are connected so that a driving pulse is transmitted through the connection electrode.

6. The fingerprint sensor-integrated touch screen panel of claim 1, wherein, in the sensing electrode group, the fingerprint sensing electrode is disposed between the touch sensing electrode rows.

7. The fingerprint sensor-integrated touch screen panel of claim 1, wherein each of the electrodes of the sensing electrode group has a line width of 10 μm to 200 μm and a pitch of 20 μm to 400 μm.

8. The fingerprint sensor-integrated touch screen panel of claim 1, wherein each of the electrodes of the driving/receiving electrode group, each of the electrodes of the sensing electrode group, and each of the electrodes of the connection electrode group are arranged with the same line width and pitch and are formed to have a line width of 10 μm to 200 μm and a pitch of 20 μm to 400 μm.

9. The fingerprint sensor-integrated touch screen panel of claim 1, wherein the active area includes a plurality of touch sensing areas parallel to the second direction,
each of the touch sensing areas is divided into a plurality of sub-touch sensing areas so as to correspond to the sub-driving/receiving electrode groups,
each of the sub-driving/receiving electrode groups corresponds to the plurality of sub-touch sensing areas disposed in the first direction, and
each of the sub-driving/receiving electrode groups includes a touch receiving electrode group including touch receiving electrodes commonly connected to the plurality of touch sensing electrodes of a corresponding one of the sub-touch sensing areas.

10. The fingerprint sensor-integrated touch screen panel of claim 1, wherein the active area includes fingerprint sensing areas each including the plurality of fingerprint sensing electrodes,
the fingerprint sensing area is divided into a plurality of sub-fingerprint sensing areas so as to correspond to the sub-driving/receiving electrode groups,
each of the plurality of fingerprint sensing electrodes in the fingerprint sensing area forms a connection pattern that is connected to correspond to each fingerprint receiving electrode of a fingerprint receiving electrode group in the driving/receiving electrode group, and
the fingerprint receiving electrode group receives signals of the sub-fingerprint sensing areas in an overlapping manner.

11. The fingerprint sensor-integrated touch screen panel of claim 10, wherein the active area includes a plurality of fingerprint sensing areas parallel to the second direction and adjacent to each other in the first direction, and
the fingerprint receiving electrode group receives signals from the plurality of fingerprint sensing areas in an overlapping manner by being commonly connected to the plurality of fingerprint sensing areas in a manner in which a connection pattern between the fingerprint sensing electrodes and the fingerprint receiving electrodes in one of the fingerprint sensing areas is formed to be the same as a connection pattern between the fingerprint sensing electrodes and the fingerprint receiving electrodes in another one of the fingerprint sensing areas.

12. The fingerprint sensor-integrated touch screen panel of claim 1, wherein the bezel area is formed in one direction outside the active area in an extending direction of the driving/receiving electrode group.

13. The fingerprint sensor-integrated touch screen panel of claim 12, wherein the bezel area is formed to be foldable on a flexible circuit board.
